(19) United States
(12) Patent Application Publication
(10) Pub. No.: US 2020/0264479 A1
(43) Pub. Date: Aug. 20, 2020

(54) LIGHTING DEVICE AND DISPLAY DEVICE

(71) Applicant: SHARP KABUSHIKI KAISHA, Sakai City (JP)

(72) Inventor: KENJI TAKASE, Sakai City (JP)

(21) Appl. No.: 16/788,096

(22) Filed: Feb. 11, 2020

Related U.S. Application Data
(60) Provisional application No. 62/808,079, filed on Feb. 20, 2019.

(51) Int. Cl. G02F 1/13357; G02F 1/1333; F21V 8/00

(52) U.S. Cl. CPC G02F 1/133606; G02F 1/133603; G02F 2001/133607; G02B 6/0078; G02B 6/0073; G02F 1/133382

(57) ABSTRACT

A lighting device includes light sources, a light source board, and a light guide plate having a light entering edge surface and plate surfaces. The light sources configure light source rows in each of which the light sources are arranged such that the light emitting surfaces are opposite the light entering edge surface. The light source board includes a first mounting section having the mounting surface opposite one plate surface, a second mounting section having the mounting surface opposite another plate surface, and connection section connecting the first and second mounting sections to be opposite and away from the light entering edge surface. Among the light source rows, the light sources of a first light source row are mounted on the first mounting section and the light sources of a second light source row are mounted on the second mounting section.

### CROSS REFERENCE TO RELATED APPLICATION

This application claims priority from U.S. Provisional Patent Application No. 62/808,079 filed on Feb. 20, 2019. The entire contents of the priority application are incorporated herein by reference.

### TECHNICAL FIELD

The technology described herein relates to a lighting device and a display device.

### BACKGROUND ART

A liquid crystal display device including a liquid crystal panel is used as a display device of mobile terminal devices such as a tablet-type personal computer, a digital camera, and a smartphone and a television. Since the liquid crystal panel does not emit light, the liquid crystal panel needs to use external light to display an image. Therefore, this type of display device includes a lighting unit (a so-called backlight unit) that supplies light to the liquid crystal panel in addition to the liquid crystal panel. The backlight unit is disposed on a back surface side of the liquid crystal panel and is configured to supply planar light toward the back surface of the liquid crystal panel.

The backlight units are generally classified into direct-type backlight units and edge light-type backlight units according to the arrangement of the LEDs that are used as the light source. The direct-type backlight unit includes the light source disposed directly below the display surface of the liquid crystal panel. The edge light-type backlight unit includes the light source disposed on a lateral side of the liquid crystal panel and light enters a light guide plate through a side surface thereof and exits the light guide plate toward the liquid crystal panel. The liquid crystal display device has been strongly demanded to reduce a thickness thereof and the edge light-type backlight unit is preferably used to achieve further reduction in thickness.

The backlight unit has been demanded to reduce a thickness and increase luminance. However, in the edge light-type backlight unit described earlier, a light emitting surface of the light source such as an. LED has a height dimension that is same as or smaller than a thickness dimension of an edge surface (a light entering surface) of the light guide plate. The edge surface is disposed opposite the light emitting surface. Therefore, if the LEDs having high output power and large light emission area are used to increase luminance, the light guide plate is necessarily increased in thickness. If a thin light guide plate is used to reduce the thickness, only small LEDs having low output poser can be used. Namely, it is difficult to achieve both of high luminance and reduced thickness.

To increase luminance, following configuration is proposed. LEDs of the side surface light emitting type that provide higher luminance than those of the top surface light emitting type while having a same size are used and the LEDs of the side surface light emitting type are arranged in two rows in a plate thickness direction of the light entering surface (the edge surface) of the light guide plate (refer FIGS. 23 and 24). Two LED boards 2 are arranged in parallel to front and back surfaces (a light exit surface 4 and a reflecting surface 5) of light guide plate 3, respectively, such that the LEDs 1 are arranged in two rows. The LED boards 2 are connected. to each other by connectors 6 or cables.

However, with the above-described configuration, the backlight unit is still demanded to reduce a thickness and increase luminance.

On the other hand, in the edge light-type backlight unit, the LEDs as the light source are locally arranged in a certain section. Therefore, if the backlight unit is used continuously for a long time, the temperature of the LEDs may increase excessively and the display quality of the display panel may be adversely affected as follows. The light emission condition of the LEDs may become unstable, or the light guide plate may be distorted and brightness and luminance may be varied. Therefore, it is demanded to reduce a thickness and also achieve heat dissipation.

Furthermore, it has been greatly demanded to reduce a frame thickness. However, in the above configuration, the LED boards 2 are arranged in the direction along the front and back surfaces 4, 5 of the light guide plate 3 and therefore, the frame width cannot be reduced easily. If the width of the LED board 2 is reduced to reduce the frame width, the wiring density on the LED board 2 necessarily becomes higher and the area for heat dissipation is reduced and this lowers heat dissipation ability.

Furthermore, in the configuration including the two LED boards the number of components such as the connectors 6 is increased and a cost is also increased.

### SUMMARY

An object of the technology described herein is to provide a lighting device and a display device that are thin and provide high luminance and also have a reduced frame width and good heat dissipation ability.

A lighting device according to the technology described herein includes light sources having light emitting surfaces through which light is emitted, a light source board having a mounting surface on which the light sources are mounted, and a light guide plate having a light entering edge surface through which the light emitted by the light sources enters. The light sources configure light source rows in each of which the light sources are arranged such that the light emitting surfaces are opposite the light entering edge surface of the light guide plate. The light source board includes a first mounting section, a second mounting section, and a connection section. The first mounting section has the mounting surface opposite one plate surface of the light guide plate, the second mounting section has the mounting surface opposite another plate surface of the light guide plate, and the connection section connects the first mounting section and the second mounting section so as to be opposite and away from the light entering edge surface of the light guide plate. Among the light source rows, the light sources of a first light source row are mounted on the first mounting section and the light sources of a second light source row are mounted on the second mounting section.

A display device according to the technology described herein includes the lighting device and a display panel displaying an image with using light supplied by the lighting device.

According to the technology described herein, a lighting device and a display device that are thin and provide high luminance and have a reduced frame width and good heat dissipation ability.

### BRIEF DESCRIPTION OF THE DRAWINGS

FIG. 1 is an enlarged cross-sectional view illustrating a portion of a liquid crystal display device according to a first embodiment with respect to the X-axis direction.

FIG. 2 is an enlarged cross-sectional view illustrating a portion of the liquid crystal display device with respect to the Y-axis direction.

FIG. 3 is a plan view of a backlight unit.

FIG. 4 is a side cross-sectional view of LEDs and a LED board.

FIG. 5 is an enlarged cross-sectional view illustrating a portion of a liquid crystal display device according to a second embodiment with respect to the X-axis direction.

FIG. 6 is an enlarged cross-sectional view illustrating a portion of a liquid crystal display device according to a third embodiment with respect to the Y-axis direction.

FIG. 7 is an enlarged cross-sectional view illustrating a portion of a liquid crystal display device according to a fourth embodiment with respect to the X-axis direction.

FIG. 8 is an enlarged cross-sectional view illustrating a portion of a liquid crystal display device according to a fifth embodiment with respect to the X-axis direction.

FIG. 9 is a plan view of a backlight unit.

FIG. 10 is an enlarged cross-sectional view illustrating a portion of a liquid crystal display device according to a sixth embodiment with respect to the X-axis direction.

FIG. 11 is an enlarged cross-sectional view illustrating a portion of the liquid crystal display device with respect to the Y-axis direction.

FIG. 12 is a side cross-sectional view of LEDs and a LED board.

FIG. 13 is an enlarged cross-sectional view illustrating a portion of a liquid crystal display device according to a seventh embodiment with respect to the X-axis direction.

FIG. 14 is an enlarged cross-sectional view illustrating a light guide plate with respect to the Y-axis direction.

FIG. 15 is an exploded plan view of a light guide plate group.

FIG. 16 is graphs representing a luminance distribution of the light guide plates.

FIG. 17 is an enlarged cross-sectional view illustrating a portion of a liquid crystal display device according to another embodiment (1) with respect to the X-axis direction.

FIG. 18 is an enlarged cross-sectional view illustrating the liquid crystal display device with respect to the Y-axis direction.

FIG. 19 is an enlarged cross-sectional view illustrating a portion of a liquid crystal display device according to another embodiment (2) with respect to the X-axis direction.

FIG. 20 is an enlarged cross-sectional view illustrating the liquid crystal display device with respect to the X-axis direction.

FIG. 21 is an enlarged cross-sectional view illustrating a portion of the light guide plate according to another embodiment with respect to the Y-axis direction.

FIG. 22 is an enlarged cross-sectional view illustrating a portion of the light guide plate according to another embodiment with respect to the Y-axis direction.

FIG. 23 is an enlarged cross-sectional view illustrating a portion of the liquid crystal display device of a related art with respect to the X-axis direction.

FIG. 24 is an enlarged cross-sectional view illustrating a portion of the liquid crystal display device with respect to the Y-axis direction.

### DETAILED DESCRIPTION

### First Embodiment

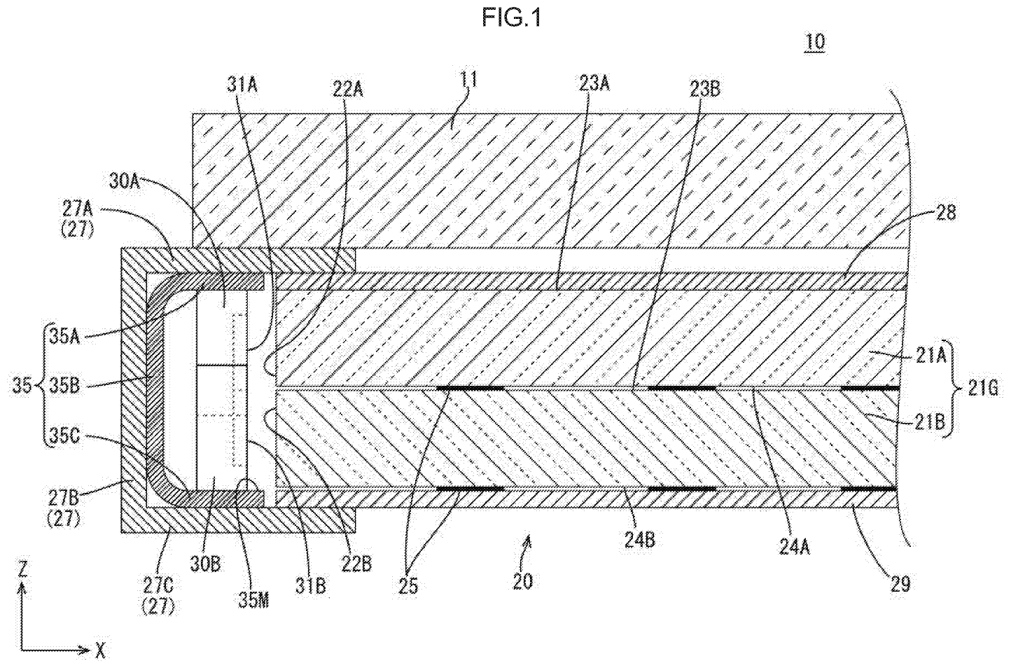

A first embodiment will be described with reference to FIGS. 1 to 4. In the section, a liquid crystal display device 10 (one example of a display device) including a liquid crystal panel 11 as a display panel will be described as examples. X-axis, Y-axis and Z-axis may be present in the drawings and each of the axial directions represents a direction represented in each drawing. A vertical direction is determined with reference to FIG. 1 and an upper side and a lower side in FIG. 1 correspond to a front side and a back side, respectively. One of the same components is provided with a symbol and other ones are not provided with the symbol.

The liquid crystal display device 10 has a rectangular flat box overall shape and includes a liquid crystal panel 11 (one example of a display panel) displaying an image and a backlight unit 20 (one example of a lighting unit) that is disposed on a back side with respect to the liquid crystal panel 11 and supplies light to the liquid crystal panel 11 for displaying. The liquid crystal panel 11 and the backlight unit 20 are integrally included in the liquid crystal display device 10. The liquid crystal display device 10 in this embodiment is used in various kinds of electronic devices as portable information terminals (for example, mobile phones, smartphones, and tablet type personal computers), onboard information terminals (for example, built-in car navigation systems and portable car navigation systems), and portable gaming machines.

The liquid crystal panel 11 includes a pair of rectangular substrates that are bonded to each other while having a certain gap therebetween and a liquid crystal layer that is disposed between the substrates. Such a configuration is well-known. The substrates are glass substrates having good light transmissivity and made of alkali-free glass or quarts glass. Multiple layers are disposed on top of each other on each of the glass substrates with the known photolithography method.

One of the substrates on the back side (on a lower side in FIG. 1) is an array substrate. Switching components (for example, TFTs), pixel electrodes that are connected to the switching components, and an alignment film are disposed on the array substrate. The switching components are connected to gate lines and source lines that are perpendicular to each other. Another one of the substrates on the front side (on an upper side in FIG. 1) is a CF substrate. Color filters including color portions of red (R), green (G), and blue (B) that are arranged in certain arrangement, an opposing electrode, and an alignment film are disposed on the CF substrate. The source lines, the gate lines, and the opposing electrode are supplied with image data and various kinds of control signals required for displaying images from a control circuit board. Polarizing plates are disposed on outer surfaces of the substrates, respectively.

The liquid crystal panel 11 displays an image with using light supplied by the backlight unit 20 and a front side thereof is a light exit side. The liquid crystal panel 11 has a long-side direction and a short-side direction that correspond to the X-axis direction and the Y-axis direction, respectively, and a thickness direction corresponds to the Z-axis direction.

The backlight unit 20 has a substantially laterally-long rectangular block plan view shape as a whole similar to the liquid crystal panel 11. The backlight unit 20 includes LEDs 30 (light emitting diodes), which are light sources, a LED board 35 on which the LEDs 30 are mounted, a light guide plate group 21G in which light emitted by the LEDs 30 travels, an optical sheet 28 disposed on the front side of the light guide plate group 21G, a reflection sheet 29 disposed on the back side of the light guide plate group 21G, and a bezel 27.

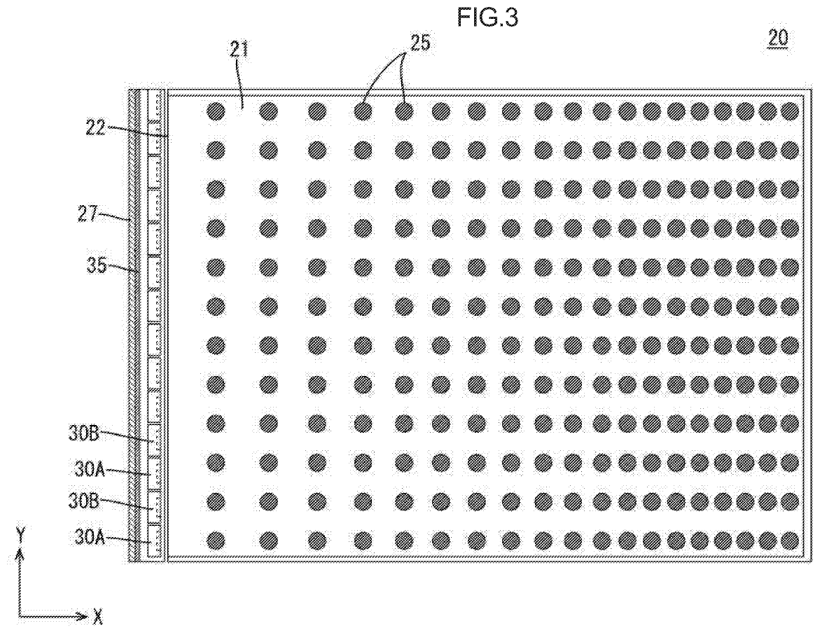

As illustrated in FIGS. 1 and 3, the backlight unit 20 is an edge light type (a side light type) backlight unit of a one-side light emitting type. The light from the LEDs 30 enters the light guide plate group 21G through one short-side edge surface. The backlight unit 20 is configured to convert the light from the LEDs 30 into planar light through the light guide plate group 21G and the planar light exits toward the liquid crystal panel 11 on the front side. Namely, the front side of the backlight unit 20 is the light exit side. Hereinafter, the components of the backlight unit 20 will be described in sequence.

The light guide plate group 21G will be described first. The light guide plate group 21G according to the present embodiment includes two light guide plates 21 including a first light guide plate 21A and a second light guide plate 21B. The first light guide plate 21A is disposed on a relatively front side and the second light guide plate 21B is disposed on the back side. The first light guide plate 21A and the second light guide plate 21B are rectangular plates having the same shape and the same size and are overlaid with each other entirely in a plan view. As illustrated in FIGS. 1 to 3, the light guide plate group 21G is disposed in such a manner that the long-side direction and the short-side direction thereof match the X-axis and the Y-axis, respectively, and the thickness direction thereof matches the Z-axis.

Hereinafter, the suffix “A” or “B” is added to the reference number to distinguish each of the light guide plates 21 such as the first light guide plate 21A or the second light guide plate 21B, and no suffix is added to generally indicate the light guide plate. The suffix “A” or “B” is added to each reference number to distinguish each of the configurations of the light guide plates 21A, 21B, and no suffix is added to generally indicate the configuration of the light guide plate. The LEDs 30, which will be described later, are indicated in the same manner.

The light guide plate 21 is made of material having a refractive index that is sufficiently higher than that of air and high light transmissivity, that is, for example, resin such as transparent acrylic or polycarbonate or various kinds of glass. This embodiment includes two acrylic resin plates as the first light guide plate 21A and the second light guide plate 21B.

The first light (guide plate 21A is disposed to be overlaid with the second light guide plate 21B on the front side with respect to the Z-axis direction, The first light guide plate 21A has outer edge surfaces and one edge surface of the outer edge surfaces that is on the left side in FIG. 3 and extends in the Y-axis direction is a first :light entering edge surface 22A through which light emitted by the LEDs 30 enters. The first light entering edge surface 22A is vertical to a front plate surface of (a first light exit plate surface 23A, which will be described later) the first light guide plate 21A and extends along a Y-Z surface.

The first light guide plate 21A has a pair of front and back plate surfaces and a plate surface on the front side (the liquid crystal panel 11 side) is the first light exit plate surface 23A and a plate surface on the back side is a first light exit opposite plate surface 24A. The light exits through the first light exit plate surface 23A toward the liquid crystal panel 11. The first light exit opposite plate surface 24A is on an opposite side from the first light exit plate surface 23A.

The second light guide plate 21B is disposed to be overlaid with the first light guide plate 21A on the back side with respect to the Z-axis direction. The second light guide plate 21B has outer edge surfaces and one edge surface of the outer edge surfaces that is on the left side in FIG. 3 and extends in the Y-axis direction is a second light entering edge surface 22B through which light emitted by the LEDs 30 enters. The second light entering edge surface 22B is vertical to a front plate surface of (a second light exit plate surface 23B, which will be described later) the second light guide plate 21B and extends along a Y-Z surface. The first light entering edge surface 22A and the second light entering edge surface 22B are on a same plane surface. Namely, the light guide plates 21 are overlapped with each other such that the respective light entering edge surfaces 22 faces the same direction. According to such a configuration, the LEDs 30 can be arranged on one side of the light guide plate group 21G.

The second light guide plate 21B has a pair of front and back plate surfaces and the plate surface on the front side is the second light exit plate surface 23B and the plate surface on the back side is a second light exit opposite plate surface 24B. Tie light exits through the second light exit plate surface 23B toward the liquid crystal panel 11. The second light exit opposite plate surface 24B is on an opposite side from the second light exit plate surface 23B.

As illustrated in FIG. 3, the first light guide plate 21A and the second light guide plate 21B include an uneven pattern on the respective light exit opposite plate surfaces 24A and 24B. The uneven pattern includes lens protrusions 25 that protrude toward the back side. The uneven pattern has a low density in a section close to the LEDs 30 (on the left side in FIG. 3) and the density of the uneven pattern is increased gradually toward an opposite side (the right side in FIG. 3). According to such a configuration, the light enters the respective light guide plates 21 through the respective light entering edge surfaces 22 and travels within the respective light guide plates 21. Then, a traveling direction of the light is altered to the Z-axis direction by the uneven pattern such that the light exits through the respective light exit plate surfaces toward the front side (the liquid crystal panel 11).

Thus, each of the light guide plates 21 in this embodiment is disposed such that an extending direction of the light entering edge surface 22 through which the light emitted by the LEDs 30 enters matches the Y-axis, the light entering direction matches the X-axis, and the light exit direction matches the Z-axis.

As illustrated in FIG. 1, such a light guide plate group 21G is disposed directly below the liquid crystal panel 11 while having the optical sheet 28 therebetween.

The optical sheet 28 is a flat rectangular sheet that has a same size as that of the first light guide plate 21A and is disposed on the light exit plate surface 23A of the first light guide plate 21A. The long-side direction and the short-side direction of the optical sheet 28 match the X-axis direction and the Y-axis direction, respectively. The optical sheet 28 is disposed between the first light guide plate 21A and the liquid crystal panel 11 such that the light exiting the light guide plate group 210 passes through the optical sheet 28 and predetermined optical effects are added to the light passing through the optical sheet 28 and the light exits toward the liquid crystal panel 11. The optical sheet 28 in this embodiment has a three-layer configuration and includes a diffuser sheet, a lens sheet, and a reflective type polarizing sheet that are disposed on top of each other from a lower layer side in this order.

On the other hand, a reflection sheet 29 is disposed on the back surface side (on the light exit opposite plate surface 24B side) of the second light guide plate 21B. The reflection sheet 29 is a flat rectangular sheet having a same size as that of the second light guide plate 21B. The long-side direction and the short-side direction of reflection sheet 29 match the X-axis direction and the Y-axis direction, respectively. The reflection sheet 29 is a sheet of synthetic resin having a white surface with good light reflectivity. The reflection sheet 29 reflects the light, which has travelled within the second light guide plate 21B and exited through the light exit opposite plate surface 24B, toward the front side (the light exit plate surface 23B) efficiently.

The bezel 27 (one example of a heat dissipation member) is disposed on one edge portion of the outer edge portion of the light guide plate group 21G where the LEDs 30 and the LED board 35, which will be described later, are disposed. The bezel 27 is made of metal material (such as aluminum metal) having good heat dissipation ability. As a whole, the bezel 27 has a channel structure having a U-shaped cross sectional shape that opens toward the light guide plate group 21G. The bezel 27 is disposed to hold the one edge portion of the light guide plate group 21G from the front and back sides thereof.

More in detail, the bezel 27 includes a first wall portion 27A, a side wall portion 27B, and a second wall portion 27C. The first wail portion 27A extends in the direction along a surface (the light exit plate surface 23A) of the light guide plate group 21G and presses the edge portion of the light guide plate group 21G from the front side via the optical sheet 28. The side wall portion 27B extends from an outer peripheral side edge portion of the first wall portion 27A toward the back side and covers the edge surface (the light entering edge surface 22) of the light guide plate group 21G from the outer peripheral side while having a predetermined distance therebetween. The second wall portion 27C extends from a lower edge of the side wall portion 27B in the direction along the back surface (the light exit opposite plate surface 24B) of the light guide plate group 21G and presses the edge portion of the light guide plate group 21G from the back side via the reflection sheet 29. Namely, the bezel 27 is configured to cover the light guide plate group 21G while being spaced from the light entering edge surface 22 and hold the light guide plate group 21G from the front and back sides via the optical sheet 28 and the reflection sheet 29, respectively.

The liquid crystal panel 11 described earlier is fixed to the first wall portion 27A on the front side (the outer peripheral side) of the bezel 27 with a fixing tape.

Next, the LEDs 30 and the LED board 35 will be described. The LED 30 includes a box casing and a LED chip that is a light emitting source and arranged in the box casing and sealed with resin material. The LED chip has one main light emitting wavelength and specifically the LED chip that emits light of single color of blue is used. The LED chip is connected to the wiring on the LED board 35 that is disposed outside the casing by a lead frame extending through the wall of the casing. Yellow phosphors that are excited by blue light emitted by the LED chip and emit light of a predefined color are dispersed in the resin material that seals the LED chip. The LED 30 emits substantially white light as an overall color.

The LED 30 has a light emitting surface 31 through which light is emitted and that is adjacent to an LED mounting surface 35M of the LED board 35. The LED 30 is a so-called side surface light emitting type LED. Therefore, compared to a top-surface light emitting type LED with a same size and having a light emitting surface that faces an opposite side from the mounting surface of the LED board, the LED 30 emits a greater amount of light rays and is preferable for achieving high luminance.

The LED 30 emits light having a certain spread area (directivity) ranging from an optical axis as a center through the light emitting surface 31. In this embodiment, the optical axis of the exit light is substantially vertical to a middle portion of the light emitting surface 31. The light rays that are emitted by the LED 30 through the light emitting surface 31 include a greatest amount of light rays that travel along the optical axis.

The LED board 35 includes a base film that is made of thermosetting resin such as urethane resin and epoxy resin, wiring formed on the base film, and a thermoplastic resin layer disposed on the base film. The wiring is for supplying electricity to the LEDs 30. The thermoplastic resin layer includes polyimide resin having thermoplastic properties, for example. The LEDs 30 are surface-mounted on the thermoplastic resin layer in a regular manner that will be described later. The LED board 35 is a so-called flexible circuit board.

The LED board 35 has a narrow and long band-like shape that has a long-side dimension substantially same as a dimension in an extending direction (the Y-axis direction) of the light entering edge surface 22 of the light guide plate 21. The LED board 35 has a short-side dimension that is greater than a thickness dimension of the light guide plate group 21G. As illustrated in FIG. 1, the LED board 35 is curved in a U-shape along an inner surface of the bezel 27 having a U-shaped cross section and is arranged in the bezel 27.

An almost entire area of ti surface of the LED board 35 that is opposite side from the mounting surface 35M is fixed to the inner surface of the bezel 27 with a fixing tape. The LED board 35 is fixed to the whole side wall portion 27B and portions of the first wall portion 27A and the second wall portion 27C closer to the side wall portion 27B. Namely, the LED board 35 is mounted to have a section (a connection section 35B) whose long-side direction and the short-side direction match the Y-axis direction and the Z-axis direction, respectively, and two sections that are on the respective two sides of the section and parallel to the X-axis direction. The LED board 35 has a U-shape as a whole. Hereinafter, the LED board 35 that is mounted in the bezel 27 (in the U-shape) includes a section extending in a direction along the surface of the light guide plate group 21G as a first mounting section 35A and a section extending in a direction along the back surface of the light guide plate group 21G as a second mounting section 35C.

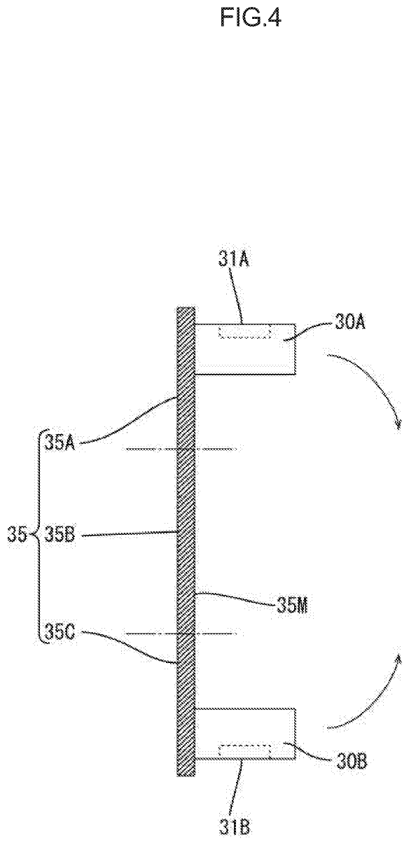

As illustrated in FIG. 4, for example, the LEDs 30 of the side-surface light emitting type on the LED board 35 are mounted on the mounting surface 35M of the first mounting section 35A and the mounting surface 35M of the second mounting section 35C. Accordingly, when the LED board 35 is arranged on the inner surface of the bezel 27 (in the U-shape curved state), the LEDs 30 are arranged such that the light emitting surfaces 31 are opposite the light entering edge surfaces 22 of the light guide plates 21.

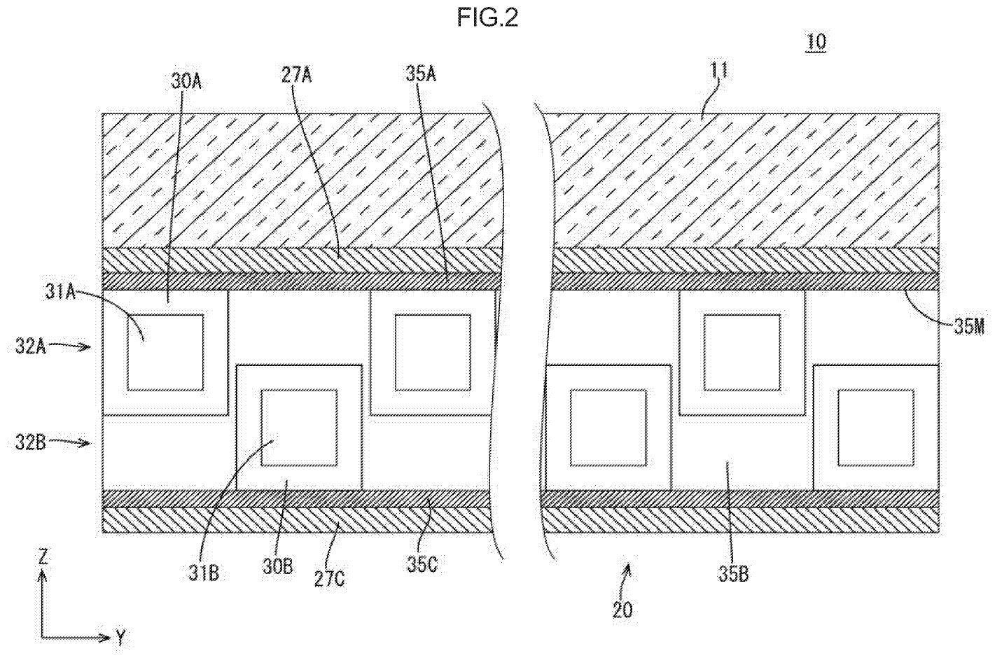

The LEDs 30 are arranged in two rows that are arranged in the short-side direction of t LED board 35. As illustrated in FIG. 2, on the LED board 35 that is mounted on the inner surface of the bezel 27 (in the U-shape curved state), the LEDs 30 are arranged in a zig-zag manner and displaced from each other with respect to the extending direction of the light entering edge surface 22 or the long-side direction of the LED board 35. Hereinafter, the LEDs 30 in one of the two rows (an upper one in FIG. 2) are referred to as first LEDs 30A and a row of the first LEDs 30A is a first LED row 32A (one example of a first light source row). The LEDs 30 in another one of the two rows (a lower one in FIG. 2) are referred to as second LEDs 30B and a row of the second LEDs 30B is a second LED row 32B (one example of a second light source row).

The first LEDs 30A of the first LED row 32A and the second LEDs 30B of the second LED row 32B are arranged alternately in a repeated manner so as not to overlap each other with respect to the extending direction of the light entering edge surface 22 (the Y-axis direction) while having a space therebetween. On the other hand, with respect to the direction (the Z-axis direction) perpendicular to the extending direction of the light entering edge surface 22, the adjacent first LED 30A and the second LED 30B are arranged to partly overlap each other. However, the adjacent light emitting surfaces 31A and 31B do not overlap. With such arrangement, the Z-axis dimension of the connection section 35B can be reduced and eventually the thickness dimension of the light guide plate group 21G can be reduced.

In this embodiment, as illustrated in FIG. 2, the LEDs 30 are arranged such that a lower edge of the light emitting surface 31A of the first LED 30A and an upper edge of the light emitting surface 31B of the second LED 30B are on a same straight line. The straight line is on the same level as a border between the first light guide plate 21A and the second light guide plate 21B with respect to the Z-axis direction.

The liquid crystal display device 10 and the backlight unit 20 according to the present embodiment have such configurations and operations and effects thereof will be described next. The backlight unit 20 according to the present embodiment includes the LEDs 30 having light emitting surfaces 31 through which light is emitted, the LED board 35 having the mounting surface 35M where the LEDs 30 are mounted, and the light guide plate 21 having the light emitting edge surface 22 through which the light emitted by the LEDs 30 enters. The LEDs 30 are included in two LED rows including the first LED row 32A and the second LED row 32B that are arranged such that the light emitting surfaces 31 are opposite the light entering edge surface 22 of the light guide plate 21. The LED board 35 includes the first mounting section 35A, the second mounting section 35C, and the connection section 35B. The first mounting section 35A has the mounting surface 35M near one plate surface (the light exit plate surface 23) of the light guide plate 21. The second mounting section 35C has the mounting surface 35M near the other plate surface (the light exit opposite plate surface 24) of the light guide plate 21. The connection section 35B connects the first mounting section 35A and the second mounting section 35C so as to be opposite and away from the light entering edge surface 22 of the light guide plate 21. The first LEDs 30A included in the first LED row 32A are mounted on the first mounting section 35A and the second LEDs 30B included in the second LED row 32B are mounted on the second mounting section 35C.

According to such a configuration, at least two LED rows 32 including the small-sized side surface light emitting type LEDs 30 having high luminance can be disposed on the one LED board 35. Namely, the backlight unit 20 and the liquid crystal display device 10 having a reduced thickness and high luminance can be obtained with simple configurations.

Furthermore, since the LED board 35 includes the connection section 35B, the heat is transferred from the first mounting section 35A and the second mounting section 35C to the connection section 35B and the heat is dissipated from the connection section 35B. The heat dissipation ability is good. Since the LED board 35 has a larger area because of the connection section 35B, the number of the wiring to be formed on the LED board 35 can be increased and a line width included in the wiring can be increased. Furthermore, the frame width can be kept substantially same as that of a prior art while increasing the area of the LED board 35.

Furthermore, since the LED board 35 is one single plate, the connectors and the cables for connecting the two LED boards are not necessary and the number of components can be reduced.

The backlight unit 20 is configured such that the first LEDs 30A included in the first LED row 32A and the LEDs included in the second LED row 32B are arranged alternately and repeatedly in the extending direction of the light entering edge surface 22 to be displaced from each other and are overlapped partially in a thickness direction of the light guide plate 21.

According to such a configuration, the short-side dimension of the LED board 35 (the connection section 35B) can be set smaller. Namely, the light guide plate 21 can be made thinner. If the light guide plate 21 having the same thickness as that of the prior art is used, the LEDs 30 that are larger in size than the prior art ones can be used and luminance can be increased.

The two light guide plates 21 are disposed on top of each other in the thickness direction thereof to configure the light guide plate group 21G. The first LED row 32A and the second LED row 32B are opposite the light entering surfaces 22 of the first lightguide plate 21A and the second light guide plate 21B of the light guide plate group 21G, respectively. Further, the first light guide plate 21A and the second light guide plate 21B are disposed on to of each other such that the light entering edge surfaces 22A and 22B thereof faces the same direction.

According to such a configuration, light can exit each of the light guide plate 21 independently from each other and high luminance can be achieved according to the lighting. Since the light guide plates 21A and 21B are disposed such that the light entering edge surfaces 22A and 22B are on a same plane surface, the first LEDs 30A and the second LEDs 30B that emit light to enter the light guide plates 21A and 21B are arranged on the same side with respect to the light guide plate group 21G. This simplifies the configuration.

The bezel 27 is disposed on an opposite surface of the mounting surface 35M of the LED board 35. The bezel 27 includes the first wall portion 27A, the second wall portion 27C, and the side wall portion 27B. The first wall portion 27A overlaps the first mounting section 35A. The second wall portion 27C overlaps the second mounting section 35C. The side wall portion 27B connects the first wall portion 27A and the second wall portion 27C and overlaps the connection section 35B.

According to such a configuration, the heat of the LED board 35 is transferred promptly to the bezel 27 and is dissipated from the bezel 27. Namely, the heat dissipation ability is further improved.

### Second Embodiment

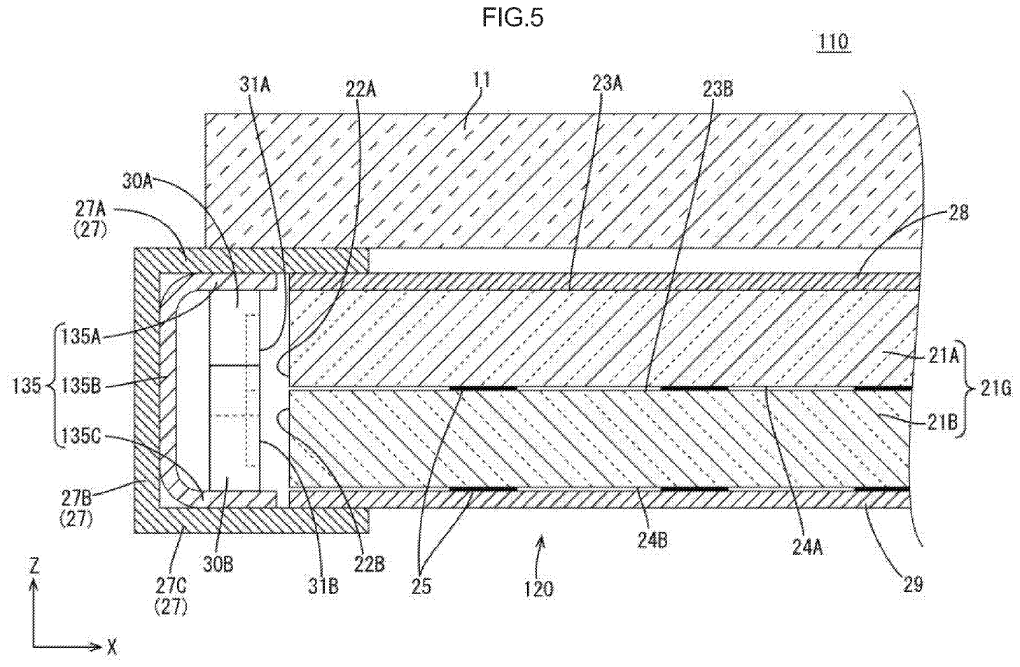

Next, a second embodiment will be described with reference to FIG. 5. In the following, configurations that differ from those in the first embodiment will be described and the components same as those in the first embodiment are provided with the same symbols and will not be described.

A backlight unit 120 in this embodiment differs from that in the first embodiment in a material of a base member of an LED board 135. Other configurations are same as those of the first embodiment. Specifically, the base member of the LED board 135 in this embodiment is made of metal material having high thermal conductivity such as gold, silver, copper, aluminum, and iron. Among them, silver has highest thermal conductivity and high reflectance; however, copper or aluminum is preferably used in view of a material cost and easiness of bending processing.

According to the backlight unit 120 and a liquid crystal display device 110 in the present embodiment, the operations and effects similar to those in the first embodiment are obtained and the heat generated by the LEDs 30 is dispersed to the LED board 135 more promptly and transferred to the bezel 27 and dissipated. Therefore, the heat dissipation ability of the LEDs 30 is improved. Accordingly, the light source light emitting efficiency obtained when the same power as that in the LED board 135 including a resin base member is supplied is improved and high luminance can be achieved.

Improvement of the heat dissipation ability prolongs life of the LEDs 30 and reduces a failure rate. Further, the rigidity of the base member of the LED board 135 is increased and the rigidity of surrounding configurations of the LED board 135 is increased.

### Third Embodiment

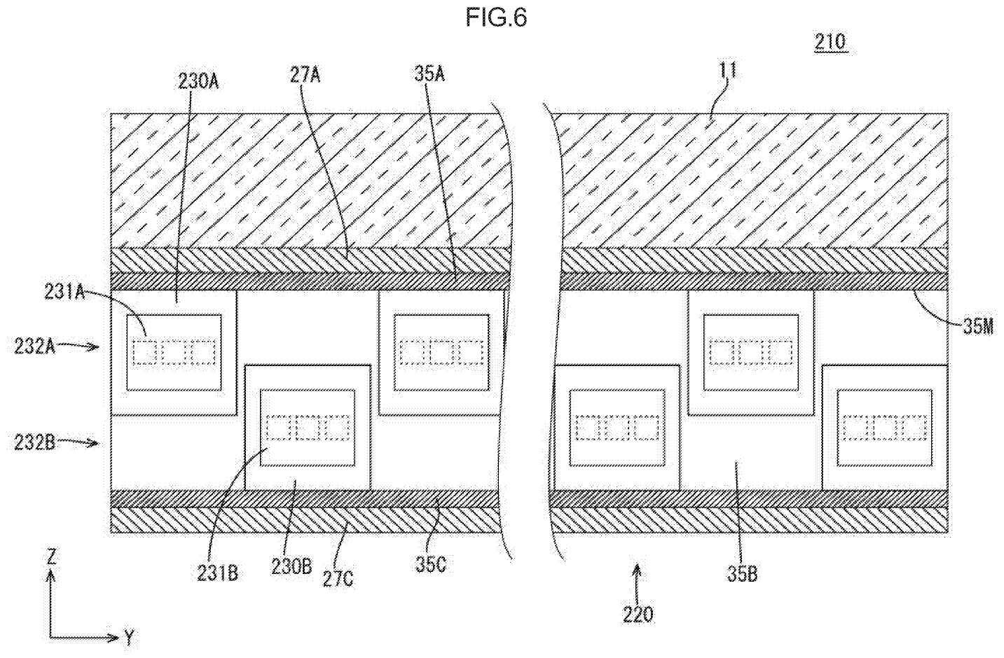

Next, a third embodiment will be described with reference to FIG. 6. In the following configurations that differ from those in the first embodiment will be described and the components same as those in the first embodiment are provided with the same symbols and will not be described.

A backlight unit 220 in this embodiment differs from that in the first embodiment in a configuration of the light source. Other configurations are similar to those in the first embodiment.

The present embodiment includes color light sources that emit light of single color of each of the three primary colors that are red, green, blue (R/G/B). The color light source includes several kinds of types such as a RGB 3-in type, a RGB independent package type, and a RGB exciting type. The color light source of the RGB 3-in type includes three kinds of LED chips of R/G/B included in one package and sealed with resin. The color light source of the RGB independent package type includes the three kinds of LED chips each of which is included and sealed independently. The color light source of the RGB exciting type includes a LED chip that has shorter wavelength than that of a color of blue and excites three kinds of phosphors of a red phosphor, a green phosphor, and a blue phosphor that are included in the sealing resin. FIG. 6 illustrates LEDs 230 including color light sources of the RGB 3-in type.

According to the backlight device 220 and a liquid crystal display device 210 in this embodiment, operations and effects similar to those in the first embodiment are obtained. Furthermore, since the light emission of each color of red, green, and blue can be controlled, light can be emitted with a wide color gamut and high color reproduction. The light source is a multicolor light source and the light emission color can be selected according to usages.

### Fourth Embodiment

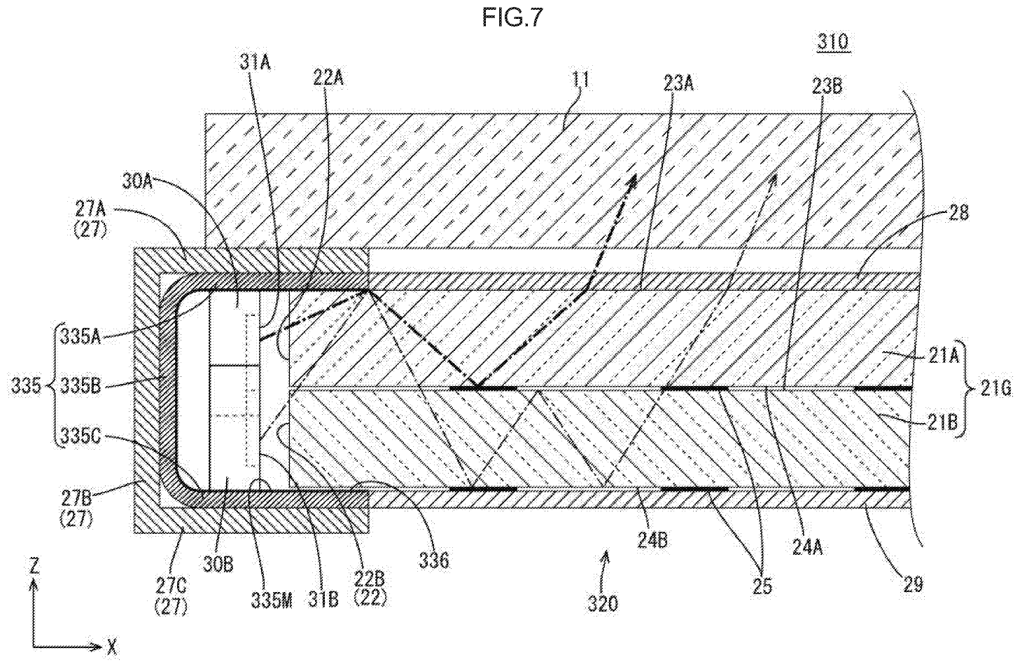

Next, a fourth embodiment will be described with reference to FIG. 7 In the following, configurations that differ from those in the first embodiment will be described and the components same as those in the first embodiment are provided with the same symbols and not be described.

This embodiment differs from the first embodiment in a configuration of a LED board 335 included in a backlight unit 320. Other configurations are similar to those in the first embodiment.

The LED board 335 in this embodiment has a greater width (a dimension in a short-dimension direction) than that in the first embodiment. A first mounting section 335A and a second mounting section 335C are overlapped with edge portions of front and back surfaces of the light guide plate group 21G, respectively. Namely, the LED board 335 is disposed to completely cover a whole portion of the light entering edge surface 22 of the light guide plate group 21G ranging from one end to another end thereof in the thickness direction without having a space. The LED board 33 includes a high reflection coating film 336 as a resist (one example of a reflecting surface) at least on mounting surfaces 335M of the first mounting section 335A and the second mounting section 335B. White coating material that reflects and scatters light and mirror coating material that mirror-reflects light are preferable for the material of the high reflection coating film 336. The coating film 336 is made of the coating material and processed with the thermosetting method or the vapor deposition method.

The light from the LEDs 30 may exit through the first light exit plate surface 23A or the second light exit opposite plate surface 24B near the light entering edge surface 22 of the light: guide plate group 21G and may be absorbed by the first wall portion 27A or the second wall portion 27C of the bezel 27. According to the backlight unit 320 and a liquid crystal display device 310 in the present embodiment, such light is reflected by the high reflection coating film 336 on the mounting surface 335M (the reflecting surface) of the LED board 335 to enter the light guide plate group 21G again. This reduces absorption of light and light use efficiency is improved and luminance of the backlight unit 320 and the liquid crystal display device 310 can be improved.

The light that is reflected by the high reflection coating film 336 is scattered. Therefore, a luminance spot is less likely to be created near the light entering edge surface of the light guide plate group 21G or if the light source is a color light source, a color mixing effect is improved and a color spot is less likely to be created.

### Fifth Embodiment

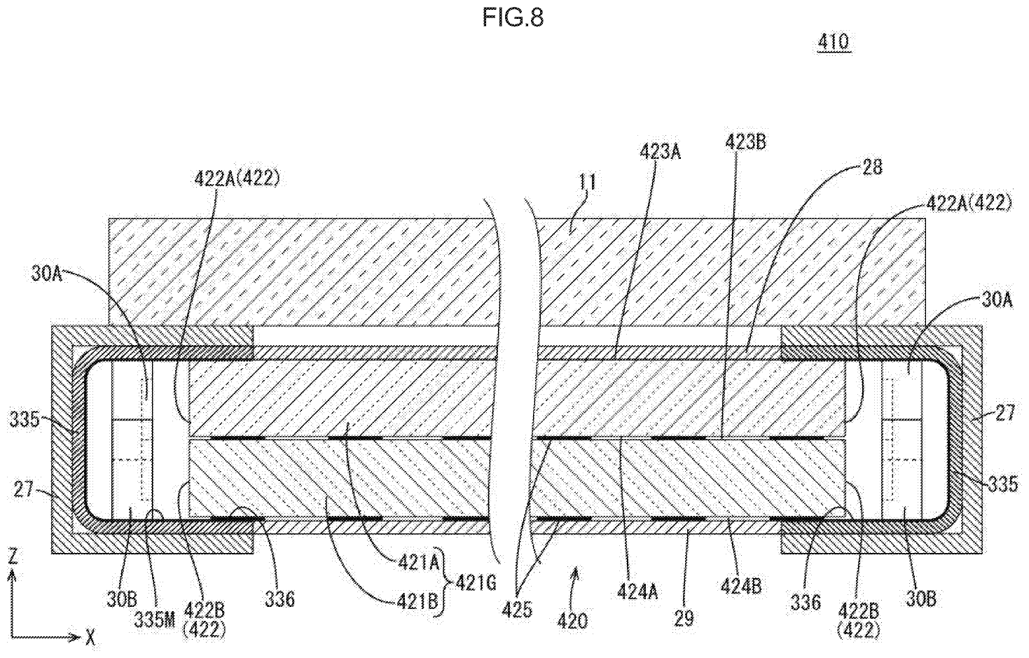

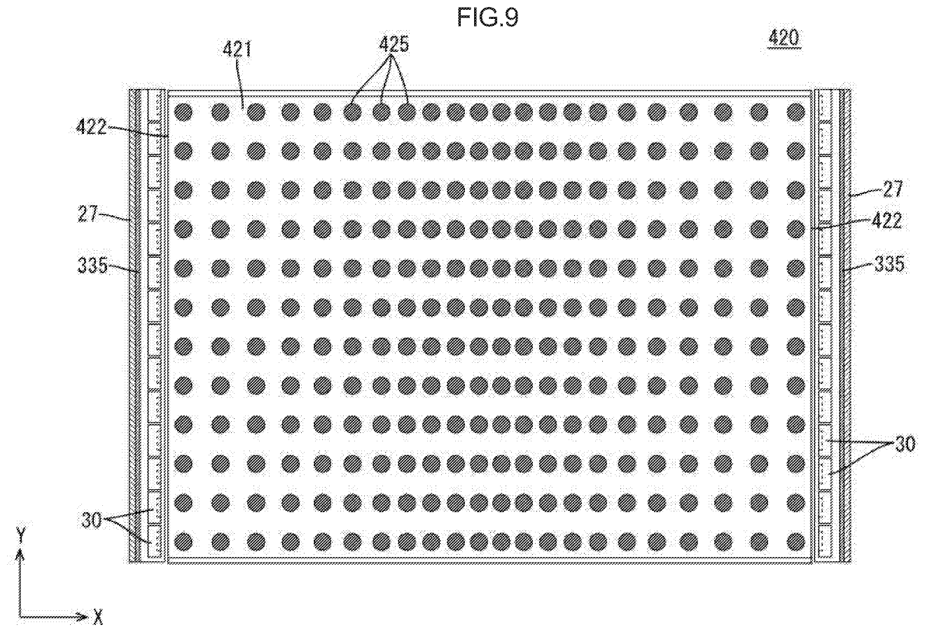

Next, a fifth embodiment will be described with reference to FIGS. 8 and 9. In the following, configurations that differ from those in the first embodiment will be described and the components same as those in the first embodiment are provided with the same symbols and will not be described.

A backlight unit 420 in this embodiment differs from that in the first embodiment in a configuration that the LEDs 30 as the light source are not only disposed on one side of a light guide plate group 421G but on opposing two sides thereof. The fifth embodiment differs from the first embodiment in that the LED board of the fourth embodiment is used as a LED board 335. Other configurations are similar to those of the first embodiment.

Specifically, the backlight unit 420 in this embodiment is a two-side light entering edge light type (side light type) backlight unit in which light from the LEDs 30 enters through opposing short-side edge surfaces of the light guide plate group 421G. The backlight unit 420 includes the LEDs 30, which are the light sources, and the bezel 27 and the configurations thereof are similar to those in the first embodiment. The LED board 335 is wide and includes the high reflection coating film 336 similarly to the fourth embodiment. The LED boards 335 are disposed on the opposing short side sections of the light guide plate group 421G while having the same structure. However, since the backlight unit 420 is a two-side light entering edge light type backlight unit, the structure of the uneven pattern of the light guide plates 421 of the light guide plate group 421G differs from that in the first embodiment.

As illustrated in FIG. 9, a first light guide plate 421A and a second light guide plate 421B include lens protrusions 425, which protrude toward the back side, on light exit opposite plate surfaces 424A and 424B thereof, respectively. The lens protrusions 425 configure an uneven pattern that differs from that in the first embodiment. The uneven pattern has a low density in two edge sections (sections close to the LEDs 30) of the light guide plate group 421G with respect to the long-side direction and the density of the uneven pattern is increased gradually toward a middle section (in a direction to be farther away from the LEDs 30). According to such a configuration, the light enters each of the light guide plates 421 through the opposing two light entering edge surfaces 422 and the light travels within each light guide plate 421. Then, the traveling direction of the light is changed by the uneven pattern in such a manner that the light travels in the Z-axis direction with substantially same intensity over an entire surface. Thus, the light exits through each of the light exit plate surfaces 423A, 423B toward the front side (toward the liquid crystal panel 11).

According to the backlight unit 420 and a liquid crystal display device 410 in the present embodiment, since the LEDs 30 are arranged on the opposing two side sections (edge sections) of the light guide plate group 421G, the luminous flux of light that exits the light guide plate group is about twice as that of the above embodiments. Therefore, the luminance becomes also about twice as that of the above embodiments. Thus, the luminance can be easily increased by increasing the number of light entering edge surfaces (the number of LEDs 430).

### Sixth Embodiment

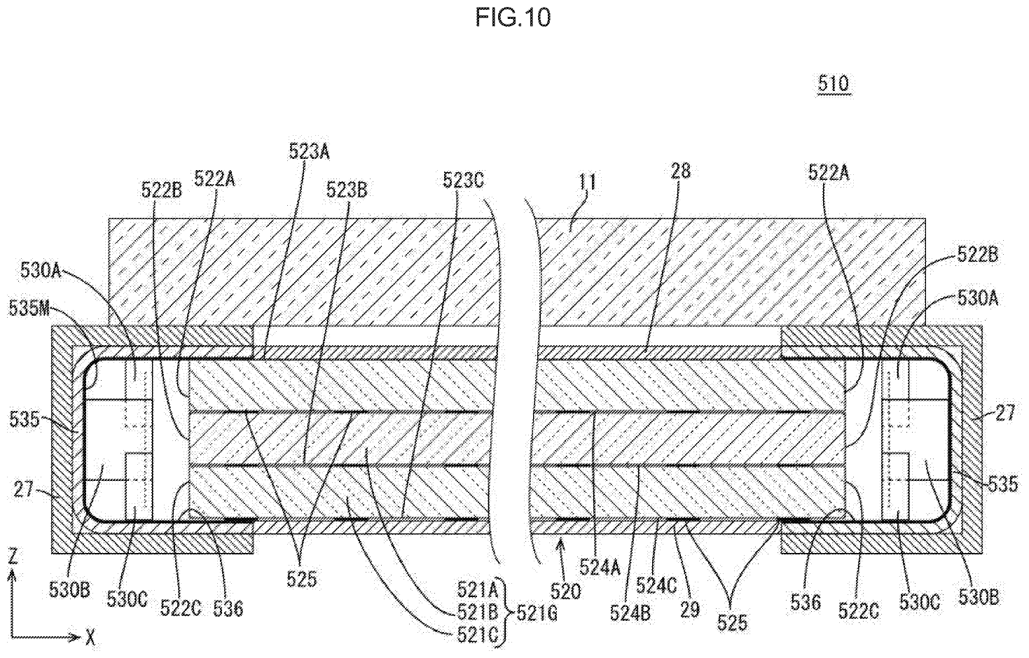

Next, a sixth embodiment will be described with reference to FIGS. 10 to 12. In the following, configurations that differ from those in the first embodiment will be described and the components same as those in the first embodiment are provided with the same symbols and will not be described.

A backlight unit 520 in this embodiment differs from that in the first embodiment as follows. The backlight unit 520 includes a light guide plate group 521G and the light guide plate group 521G includes three light guide plates 521. Accordingly, LEDs 530 are arranged at three levels such that light from the LEDs 530 enters the respective light guide plates 521. The color light sources of the RGB 3-in type are used as the LEDs 530 similarly to the third embodiment. An LED board 535 is made of metal similarly to the second embodiment and is wide similarly to the fourth embodiment. Further, similarly to the fifth embodiment, the sixth embodiment includes the two-side light entering edge light type (the side-light type) backlight unit. Other configurations are similar to those in the first embodiment.

The light guide plate group 521G according to the present embodiment includes three light guide plates 521 including a first light guide plate 521A, a second light guide plate 521B, and a third light guide plate 521C. The first light guide plate 521A is disposed on a relatively front side. The second light guide plate 521B is disposed on a back side of the first light guide plate 521A. The third light guide plate 521C is on the back side of the second light guide plate 521B. The first to third light guide plates 521A, 521B, 521C are rectangular plates having the same shape and the same size and are overlaid with each other entirely in a plan view. The first to third light guide plates 521A, 521B, 521C are made of acrylic resin.

The light guide plates 521 (the first to third light guide plates 521A, 521B, 521C) of the light guide plate group 521G include edge surfaces (short-side edge surfaces) out of outer peripheral edge surfaces that are on the left side in FIG. 10 and extend in the Y-axis direction and edge surfaces (short-side edge surfaces) that are on the right side in the same drawing and extend in the Y-axis direction. The edge surfaces are light entering edge surfaces 522 through which light emitted by the LEDs 530 enters. Namely, the light guide plates 521 are overlapped with each other in such a manner that the light entering edge surfaces 522 face the same direction. This allows the LEDs 530 to be collectively arranged on two short-side sections of the light guide plate group 521G. Each light guide plate 521 has a pair of front and back side plate surfaces. The front side plate surface (on the liquid crystal panel 11 side) is a light exit plate surface 523 through which the light exits toward the liquid crystal panel 11 and the back side plate surface is a light exit opposite plate surface 524 that is on an opposite side from the light exit plate surface 523.

Each light guide plate 521 includes the uneven pattern including lens protrusions 525 that protrude toward the back side. The uneven pattern has a low density in two edge sections (sections close to the LEDs 530) of the light guide plate group 521G with respect to the long-side direction and the density of the uneven pattern is increased gradually toward a middle section (in a direction to be farther away from the LEDs 530) similarly to the fifth embodiment (FIG. 9). According to such a configuration, the light enters each of the light guide plates 521 through the light entering edge surfaces 522 and the light travels within each light guide plate 521. Then, the traveling direction of the light is changed by the uneven pattern in such a manner that the light travels in the Z-axis direction with substantially same intensity over an entire surface. Thus, the light exits through each of the light exit plate surfaces 523 toward the front side (toward the liquid crystal panel 11).

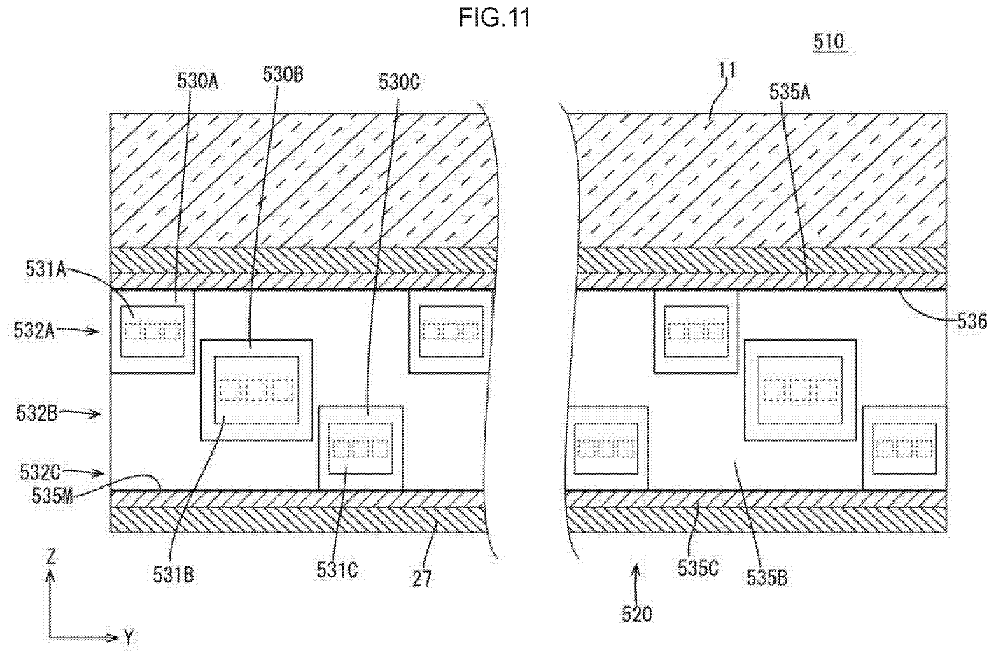

Next, the LEDs 530 and the LED board 535 will be described. As illustrated in FIG. 11, the LEDs 530 in this embodiment are mounted on the LED board 535 in three rows that are arranged in the short-side direction of the LED board 535. When the LED board 535 is arranged on the inner surface of the bezel 27 (curved in a U-shape), the LEDs 530 are arranged in such a manner that every three LEDs 530 are displaced from each other in the long-side direction of the LED board 535, that is, the extending direction of the light entering edge surface 522 and the three LEDs 530 are arranged in a repeated manner. Hereinafter, the LEDs 530 arranged in the three rows include first LEDs 530A, second LEDs 530B, and third LEDs 530C from above. A row of the first LEDs 530A is a first LED row 532A (one example of the first light source row), a row of the second LEDs 530B is a second LED row 532B, and a row of the third LEDs 530C is a third LED row 532C (one example of the second light source row).

The LED board 535 has a long-side direction that matches the Y-axis direction. With respect to the short-side direction, the LED board 535 includes a first mounting section 535A and a second mounting section 535C that extend in the X-axis direction, and a connection section 535B that extends in the Z-axis direction and connects the edge portions of the respective mounting sections 535A and 535C. The LED board 535 has a U-shape as a whole.

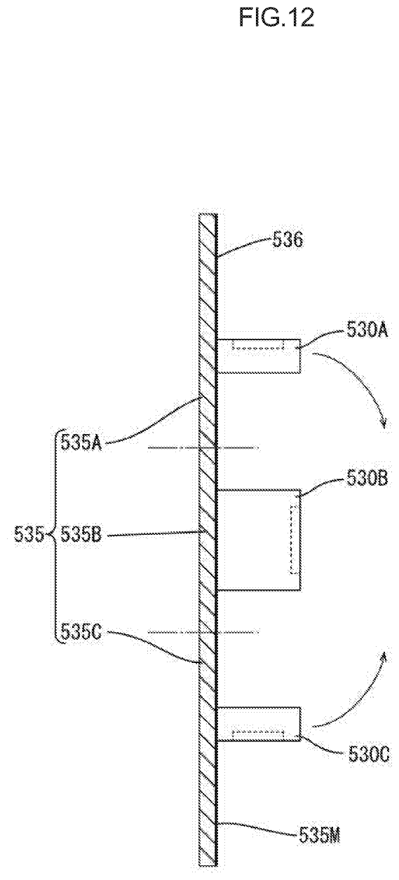

As illustrated in FIG. 12, for example, the LEDs 530 that are fixed on the LED board 535 include the first LEDs 530A and the third LEDs 530C of the side-surface light emitting type that are mounted on a mounting surface 535M of the first mounting section 535A and the second mounting section 535C and the second LEDs 530B of the top-surface light emitting type that are mounted on the connection section 535B. According to such a configuration, when the LED board 535 disposed on the inner surface of the bezel 27 (is curved in a U-shape), the tree LED rows are arranged such that the light emitting surfaces 531 thereof face the light entering edge surfaces 522 (face the same direction). The first LEDs 530A, the third LEDs 530C, and the second LEDs 530B have similar luminance when being supplied with same electricity. If the luminance of the LEDs is similar, the top-surface light emitting type LED 530B has a greater size than the side-surface light emitting type LED 530A, 530C. As illustrated in FIG. 11, an area occupied by the second LED 530B is larger than an area occupied by each of the first LED 530A and the third LED 530C.

The first LEDs 530A of the first LED row 532A (one example of the first light source row) , the second LEDs 503B of the second LED row 532B, and the third LEDs 530C of the third LED row 532C (one example the second light source row) are arranged to be spaced and displaced from each other in such a manner that the mounting areas thereof do not overlap each other with respect to the extending direction of the light entering edge surface 522. On the other hand, with respect to the thickness direction of the light guide plate 521, the mounting areas of the first LED 530A and the second LED 530B that are adjacent to each other partially overlap and the mounting areas of the second LED 530B and the third LED 530C partially overlap. For example, as illustrated in FIG. 11, a lower edge portion of the first LED 530A and an upper edge portion of the second LED 530B overlap and a lower edge portion of the second LED 530B and an upper edge portion of the third LED 530C overlap. According to such arrangement, the Z-axis dimension of the connection section 535B of the LED board 353 can be reduced and this reduces a thickness dimension of the light guide plate group 521G (the light guide plate 521).

In the present embodiment, as described earlier, the lower edge of the light emitting surface 531A of the first LED 530A and the upper edge of the light emitting surface 531B of the second LED 530B are next to each other and on the same straight line. The straight line is on the same level as a border surface of the first light guide plate 521A and the second light guide plate 5218 with respect to the Z-axis direction. Similarly, the lower edge of the light emitting surface 531B of the second LED 530B and the upper edge of the light emitting surface 531C of the third LED 530C are next to each other and on the same straight line. The straight line is on the same level as a border surface of the second light guide plate 521B and the third light guide plate 521C with respect to the Z-axis direction.

According to the backlight unit 520 and a liquid crystal display device 510 in the present embodiment, when the light exits the three light guide plates 521 at the same time, luminance is further increased compared to the above embodiments.

### Seventh Embodiment

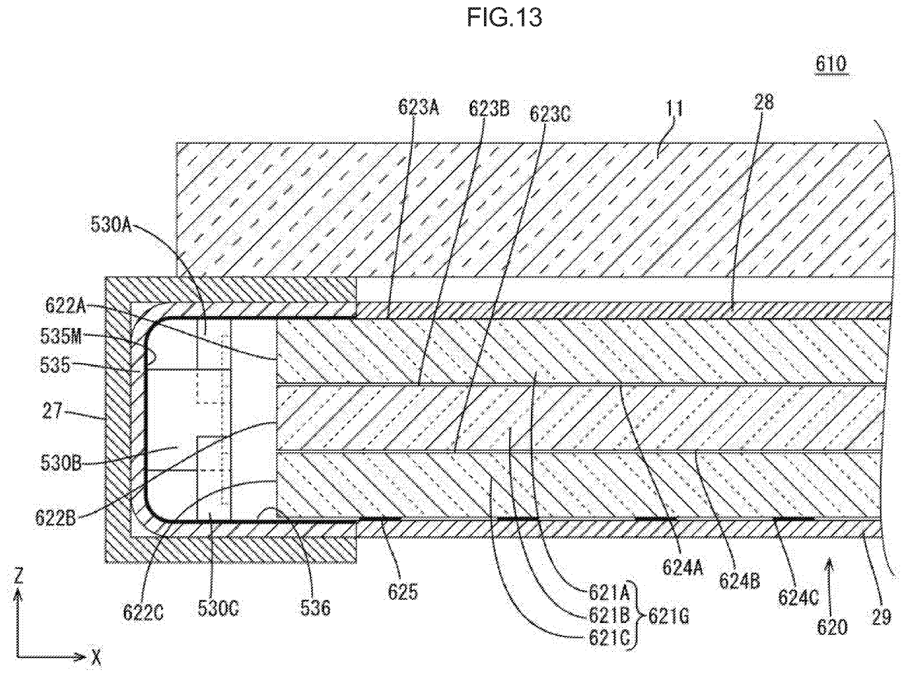

Next, a seventh embodiment will be described with reference to FIGS. 13 to 16. In the following, configurations that differ from those is the sixth embodiment will be described and the components same as those in the sixth embodiment are provided with the same symbols and will not be described.

The present embodiment differs from the sixth embodiment in that a backlight unit 620 is a backlight unit with local dimming. In the backlight unit 620, a light guide plate group 621G is divided into light emission areas such that the luminance can be adjusted for every light emission area. The present embodiment differs from the sixth embodiment in that the backlight unit 620 is a one-side light emitting edge light type backlight unit. Other configurations are similar to those in the sixth embodiment.

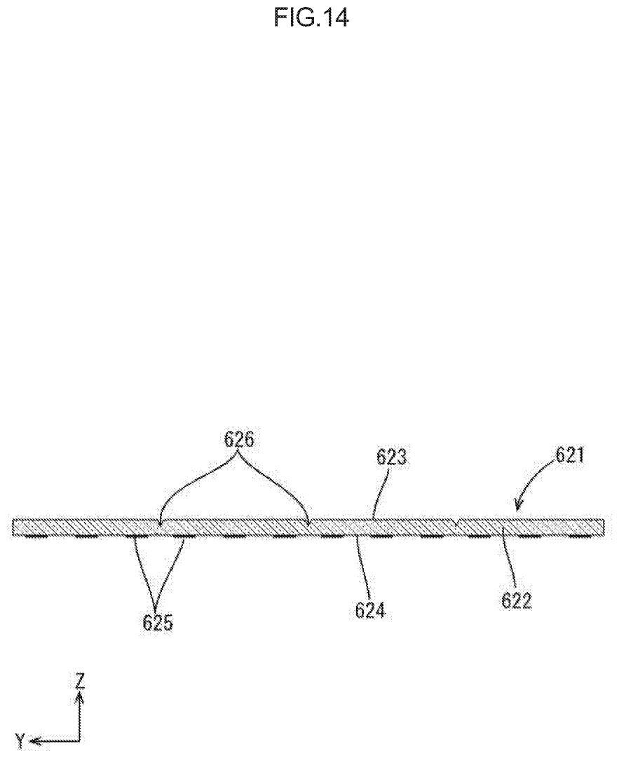

In the backlight unit 620, each light guide plate 621 includes grooves 626 (an extending structure) extending in the X-axis direction on a light exit plate surface 623. The grooves 626 are provided on the light exit plate surface 623 sequentially from the edge with respect to the short-side direction such that every three LEDs 530 are positioned between the grooves 626 (the groove 626 is between a set of three LEDs 530 and another set of three LEDs 530). As illustrated in FIG. 14, the groove 262 has V-shaped cross section and functions as a prism that changes a traveling direct ion of the light that has reached the prism. The light exit plate surface 623 is divided into areas by the grooves 626 with respect to the Y-axis direction such that divided areas each having a band-like shape and extending along the X-axis are formed. The grooves 626 are formed to exert a so-called light confinement effect to suppress the light that has travelled within one separated area from being dispersed to a next divided area. The grooves 626 are formed in any areas as long as they are at least near the border between the divided areas and may be formed in any other areas.

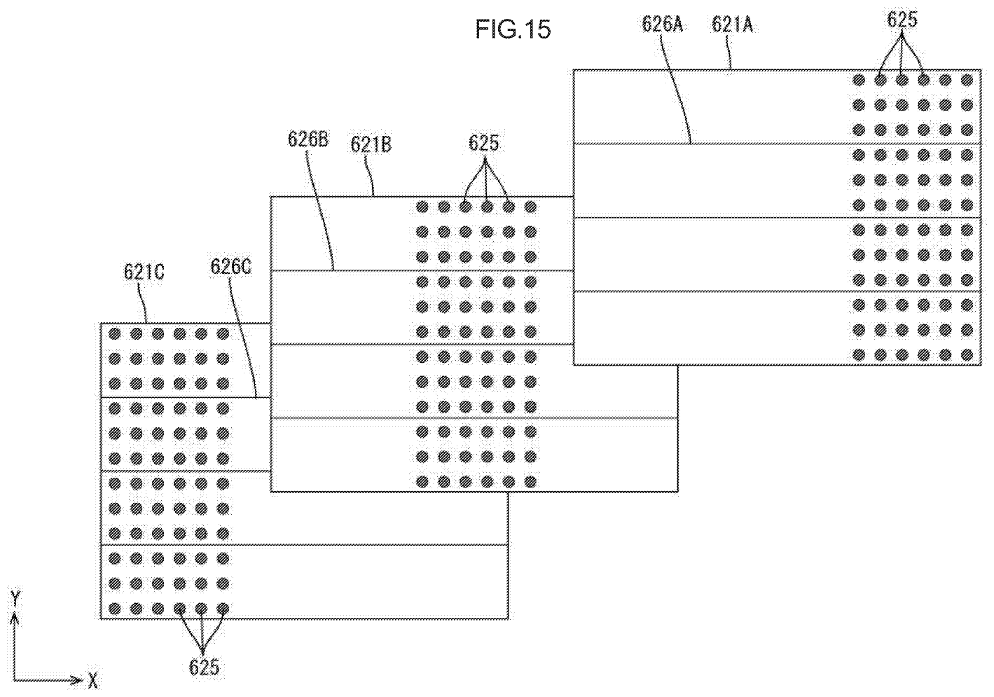

The uneven pattern including lens protrusions 625 protruding toward the back side is on a certain area of a light exit opposite plate surface 624. The uneven pattern has a function of making the light that has travelled within the light guide plate 621 to exit toward the outside (toward the light exit plate surface 623). In this embodiment, as illustrated in FIG. 15, the light exit opposite plate surface 624 is divided into three areas with respect to the X-axis direction. On the first light exit opposite plate surface 624A of the first light guide plate 621A, a first uneven pattern is disposed on. an area farther away from a first light entering edge surface 622A (on a right side in FIG. 15). On the second light exit opposite plate surface 624B of the second light guide plate 621B, a second uneven pattern is disposed on a middle area. On the light exit opposite plate surface 624C of the third light guide plate 621C, a third uneven pattern is disposed on an area closer to a light entering edge surface 622C (on the left side in FIG. 15). The first uneven pattern, the second uneven pattern, and the third uneven pattern have a uniform density.

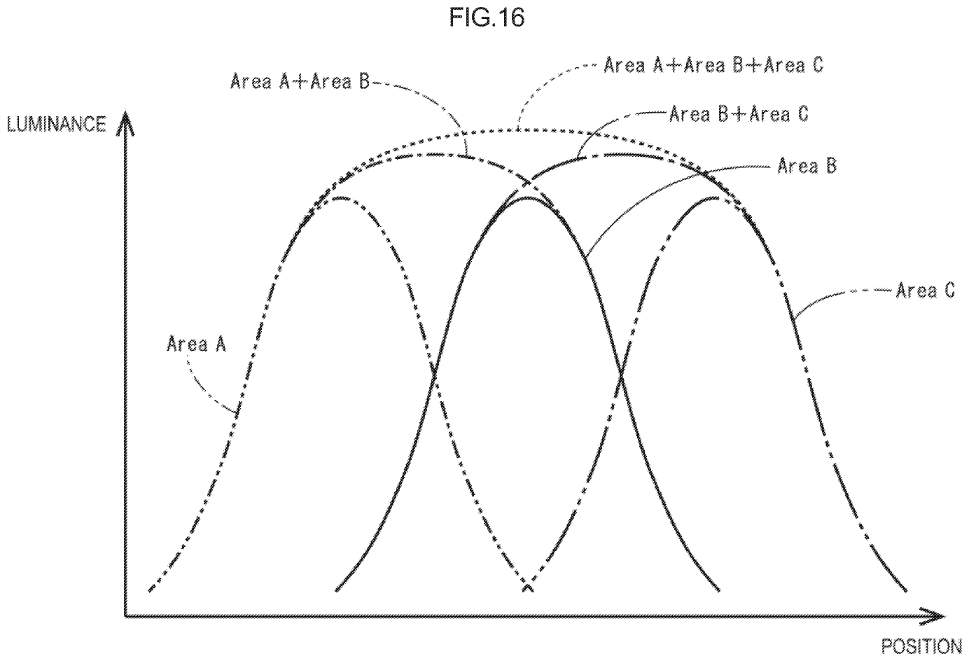

Accordingly, each light exit plate surface 623 is divided into three areas with respect to the X-axis direction and multiple areas with respect to the Y-axis direction according to the combination of the grooves 626 and the uneven patterns and the light guide plate group 621G has multiple areas. Namely, the light guide plates 621A, 621B, 621C have different luminance distributions and have a function of local dimming such that the light can exit each of the divided areas independently. All of the divided areas have a same area. The areas are defined as an area A, an area B, and an area C sequentially from the LED 530 side. FIG. 16 illustrates graphs representing the luminance distributions when light exits each of the areas.

According to such a configuration, the present embodiment has the operations and effects similar to those of the above embodiments. Furthermore, when each LED 530 emits light independently, light can exit through only a specific portion of the light guide plate 621 and local dimming control can be performed. Since the light exit plate surface 623 includes the grooves 626, straight directivity of the light is increased and the local light emission becomes easy.

### Other Embodiments

The present technology is not limited to the embodiments described in the above descriptions and drawings. The following embodiments may be included in the technical scope.

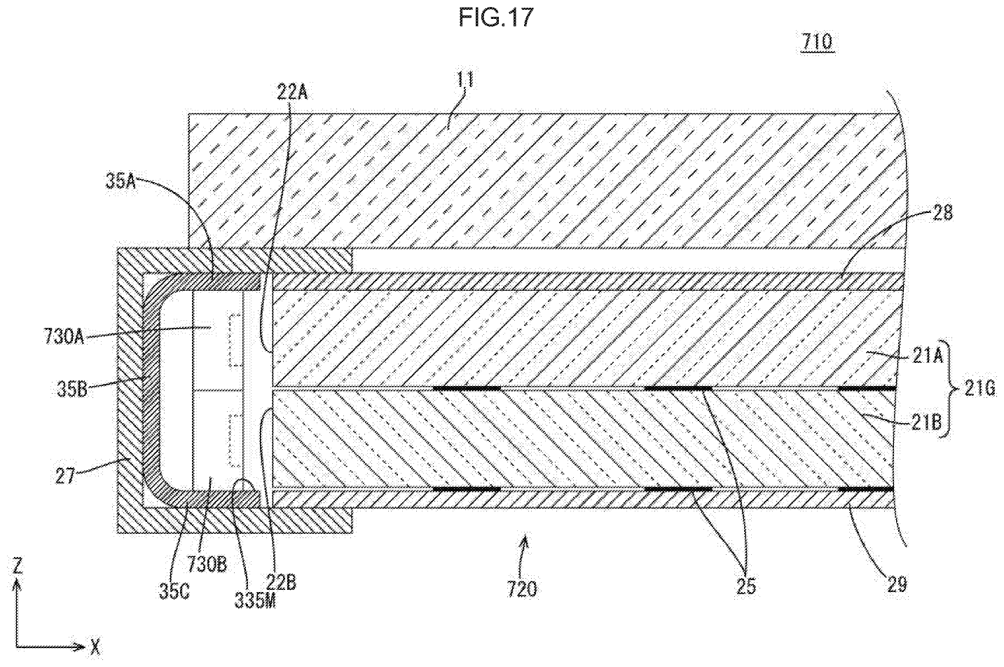

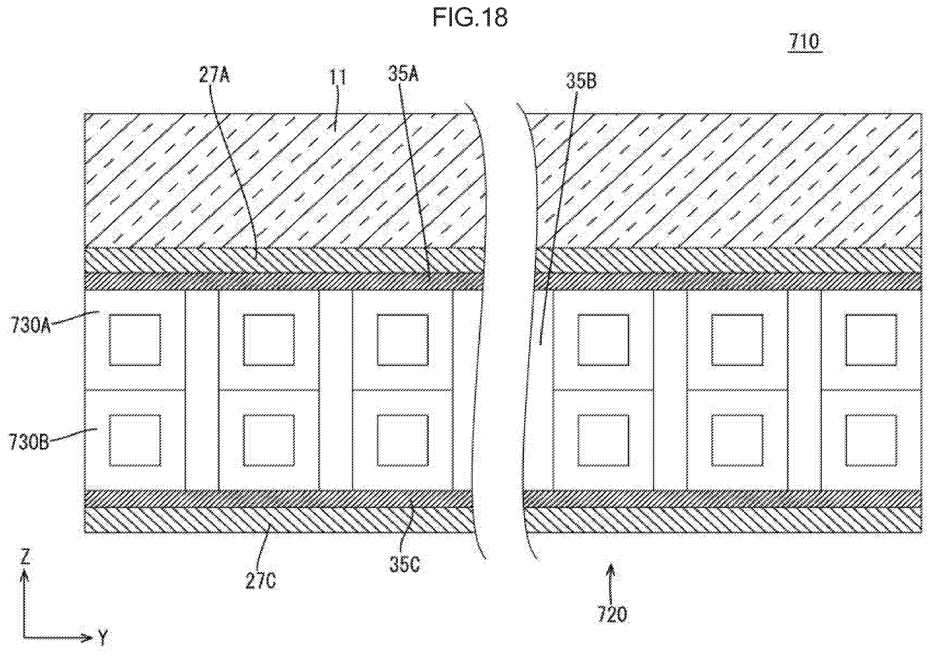

(1) For example, in the first embodiment, the two light source rows are disposed in such a manner that the first LEDs 30A of the first LED row 32A are displaced from the LEDs 30B of the second LED row 32B with respect to the extending direction of the light entering edge surface 22 in a repeated manner and the first LEDs 30A of the first LED row 32A partially overlap the LEDs 30B of the second LED row 32B with respect to the thickness direction of the light guide plate 21. However, the light sources may not be arranged to be displaced from each other in a repeated manner. For example, as illustrated in FIGS. 17 and 18, liquid crystal display device 710 (a backlight unit 720) may include LEDs that are on the same position with respect to the extending direction of the light entering edge surface 22 (the Y-axis direction). Such a configuration is also included in the technical scope of the present technology. With such a configuration, since the side-surface light emitting type LEDs 730 are used. Therefore, high luminance and reduced thickness are achieved and the heat dissipation ability is improved by the connection section 35B.

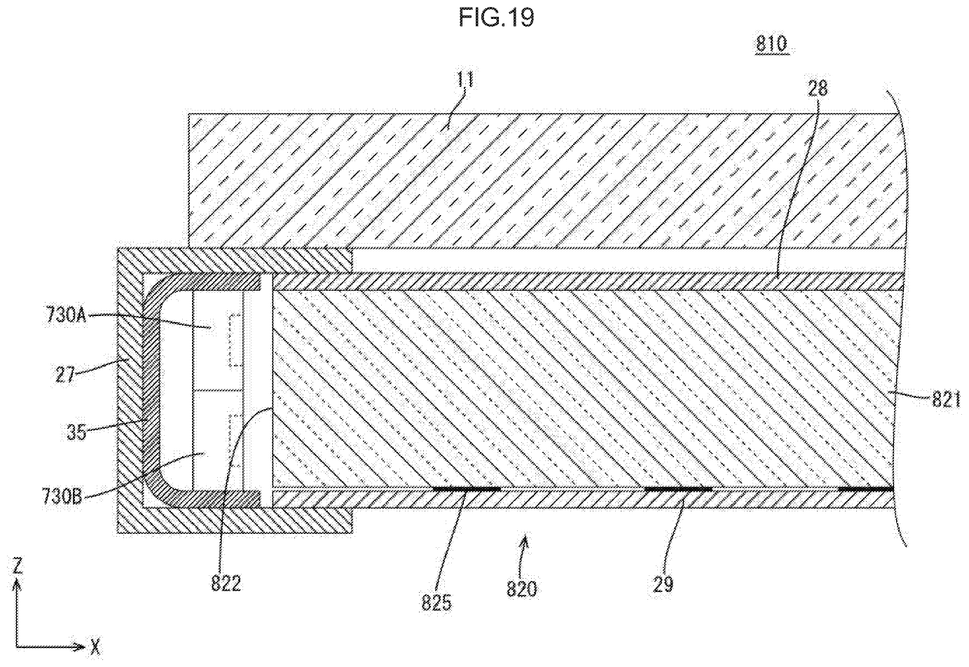

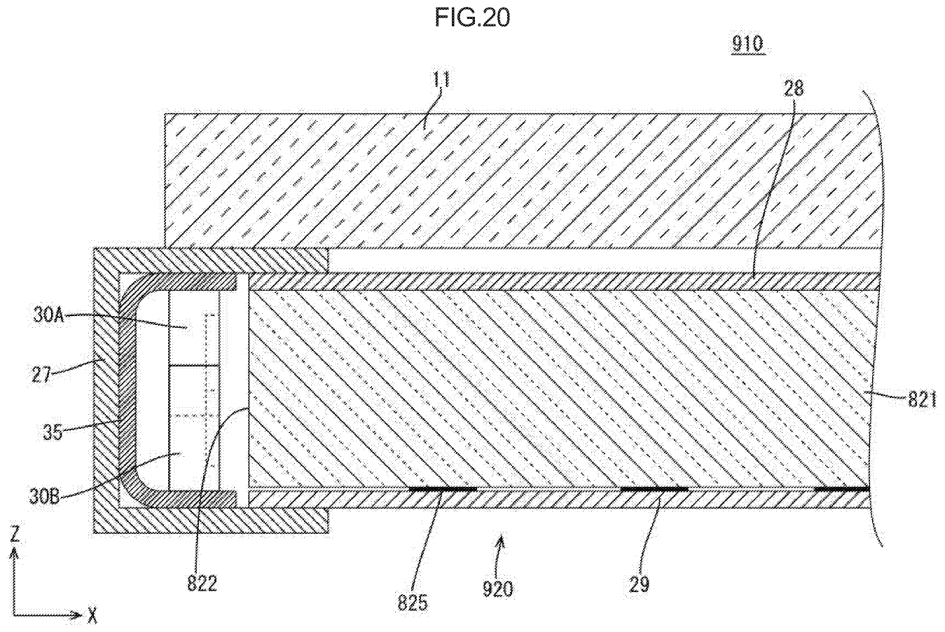

(2) In the above embodiments, the backlight unit including the light guide plate group including light guide plates is described. However, as illustrated in FIGS. 19 and 20, a liquid crystal display device 810 (a backlight unit 820) and a liquid crystal display device 910 (a backlight unit 920) may include a single light guide plate 821. In such a configuration, the LEDs 730, 30 are disposed opposite a light entering edge surface 822 of the light guide plate 821 that is a single plate.

(3) In the fourth embodiment, the LED board 335 includes the high reflection coating film 336. However, if the LED board originally has high light reflectance, the high reflection coating film 336 may not be included.

(4) The light guide plate does not necessarily have a quadrangular shape like the above embodiments but may have a circular shape or a polygonal shape. The light guide plate group may include four or more light guide plates.

(5) The position on the light guide plate where the light source is disposed is not limited to one side or opposing sides but may be three or more sides or a curved surface if the light guide plate is circular.

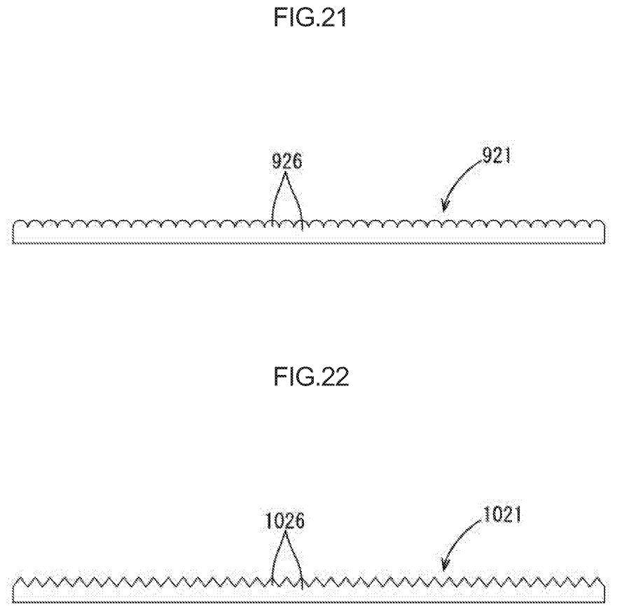

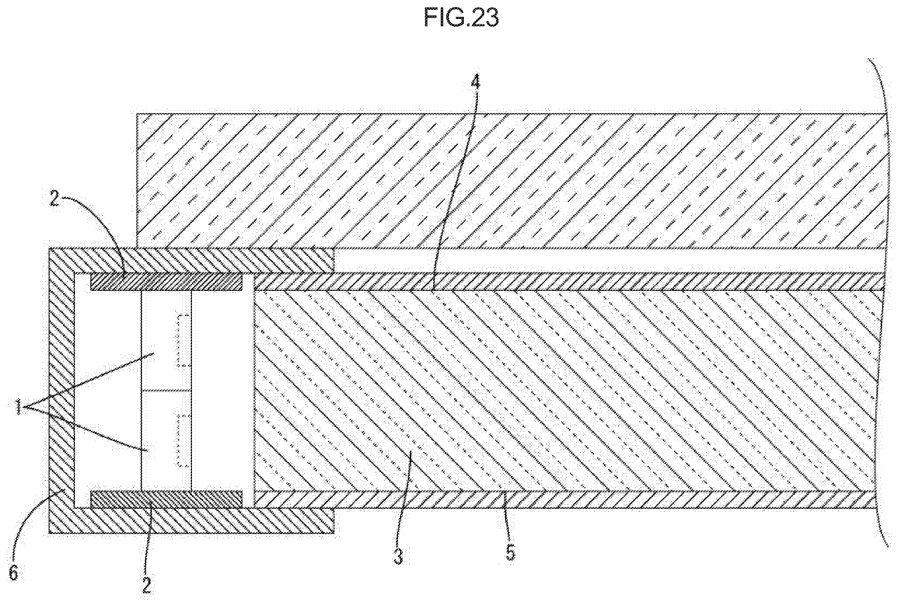

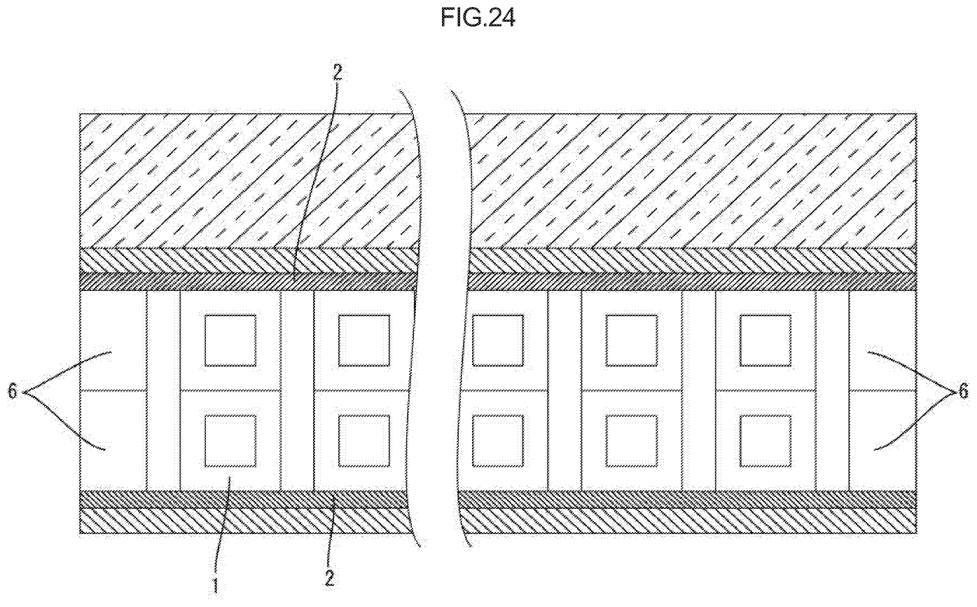

(6) In the seventh embodiment, the light guide plate 621 includes the grooves 626 (the extending structure) extending in the X-axis direction for every three LEDs 530. However, the light guide plate has any structure as long as the structure is at least disposed near the border between the divided areas and has a function of changing the direction of light that has reached the structure. For example, a light guide plate 921 including continuous prisms 926 or a light guide plate 1021 including ventricular lenses 1026 may be used (refer FIGS. 21 and 22).

1. A lighting device comprising:
light sources having light emitting surfaces through which light is emitted;
a light source board having a mounting surface on which the light sources are mounted; and
a light guide plate having a light entering edge surface through which the light emitted by the light sources enters, wherein
the light sources configure light source rows in each of which the light sources are arranged such that the light emitting surfaces are opposite the light entering edge surface of the light guide plate,
the light source board includes a first mounting section, a second mounting section, and a connection section, and the first mounting section has the mounting surface opposite one plate surface of the light guide plate, the second mounting section has the mounting surface opposite another plate surface of the light guide plate, and the connection section connects the first mounting section and the second mounting section so as to be opposite and away from the light entering edge surface of the light guide plate, and
among the light source rows, the light sources of a first light source row are mounted on. the first mounting section and the light sources of a second light source row are mounted on the second mounting section.

2. The lighting device according to claim 1, wherein the light sources of one light source row and the light sources of an adjacent light source row are arranged to be displaced from each other with respect to an extending direction of the light entering edge surface sequentially in a repeated manner and overlap partially with respect to a thickness direction of the light guide plate.

3. The lighting device according to claim 1, wherein the light guide plate includes at least two light guide plates that are disposed on top of each other in a thickness direction of the light guide plates and configured as a light guide plate group, and the one light source row is opposite the light entering edge surface of one light guide plate of the light guide plate group.

4. The lighting device according to claim 3, wherein the light guide plate group includes at least three light guide plates and the light sources are mounted on the connection section of the light source board.

5. The lighting device according to claim 1, further comprising a heat dissipation member disposed on an opposite surface of the light source board opposite from the mounting surface, the heat dissipation member including a first wall portion overlapping the first mounting section, a second wall portion overlapping the second mounting section, and a side wall portion connecting the first wall portion and the second wall portion and overlapping the connection section.

6. The lighting device according to claim 1, wherein the light source board is made of metal material.

7. The lighting device according to claim 1, wherein the light sources are color light sources configured to emit light of each single color of three primary colors that are red, green, blue (R/G/B).

8. The lighting device according to claim 1, wherein the first mounting section and the second mounting section of the light source board overlap edge portions of plate surfaces of the light guide plate, and the first mounting section and the second mounting section include the mounting surface reflecting surface that reflects light.

9. The lighting device according to claim 1, wherein the light sources are arranged at least on opposing edge portions of the light guide plate.

10. The lighting device according to claim 1, wherein the light guide plate is defined into areas and luminance can be adjusted for every area.

11. A display device comprising:
the lighting device according to claim 1; and
a display panel displaying an image with using light supplied by the lighting device.
